(19) United States
(12) Patent Application Publication
(10) Pub. No.: US 2013/0175425 A1
(43) Pub. Date: Jul. 11, 2013

(54) ROTOR RETRIEVAL TOOL

(71) Applicant: Martin James Burger, Columbia Valley (CA)

(72) Inventor: Martin James Burger, Columbia Valley (CA)

(21) Appl. No.: 13/658,759

(22) Filed: Oct. 23, 2012

Related U.S. Application Data
(60) Provisional application No. 61/551,854, filed on Oct. 26, 2011.

(51) Int. Cl. F16M 13/02

(52) U.S. Cl. CPC F16M 13/02
USPC 248/637

(57) ABSTRACT

A tool is presented that assists in the assembly, disassembly, maintenance and retrieval of elements of a hydrodynamic array, such as a drive train. The tool can function like a clamp in facilitating the removal of a turbine assembly from a nested machinery chamber or caisson module with the use of an overhead gantry crane.

### CROSS-REFERENCE TO A RELATED APPLICATION

This application claims the benefit of Provisional Application No. 61/551854, filed Oct. 26, 2011, which is incorporated herein by reference.

### BACKGROUND

A hydrodynamic array is a large infrastructure that harvests renewable energy in the form of tidal power from the ocean or river. The hydrodynamic array is composed of hydrodynamic elements each of which comprises one or more rotor assemblies supported by a quartet of columns that sit upon a base block on the sea floor and is figured to receive the motion of ocean tides or river currents acting against each hydrodynamic element to generate electricity. The quartet of columns supports a nested machinery chamber, which houses journal and thrust bearings configured to mechanically couple to the rotor assemblies. A tool is desired to assist in the assembling/disassembling of many pieces of equipment in the nested machinery chamber including the rotor assemblies.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the claimed subject matter includes a product form reciting a tool for securing elements of a hydrodynamic array. The tool comprises a first jaw having a first collar with bars extending from the first collar. The tool further comprises a second jaw having a second collar with bars extending from the second collar. The first jaw and the second jaw are configured to be brought together as two opposable parts whose ends terminate in a hinge joint for permitting motion in one plane.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric perspective view of an archetypical tool in accordance with an embodiment of the present subject matter;

FIG. 2 is a bottom plan view of an archetypical tool in accordance with an embodiment of the present subject matter;

FIG. 3 is a top plan view of an archetypical tool in accordance with an embodiment of the present subject matter; FIG. 4 is a side view of an archetypical tool in accordance with an embodiment of the present subject matter;

FIG. 5 is a side view of an archetypical tool in accordance with an embodiment of the present subject matter;

FIG. 6 is a front view of an archetypical tool in accordance with an embodiment of the present subject matter;

FIG. 7 is a back view of an archetypical tool in accordance with an embodiment of the present subject matter;

FIG. 8 is an exploded perspective view of an archetypical tool in accordance with an embodiment of the present subject matter; and

FIG. 9 is a perspective view of an archetypical tool in use in accordance with an embodiment of the present subject matter.

### DETAILED DESCRIPTION

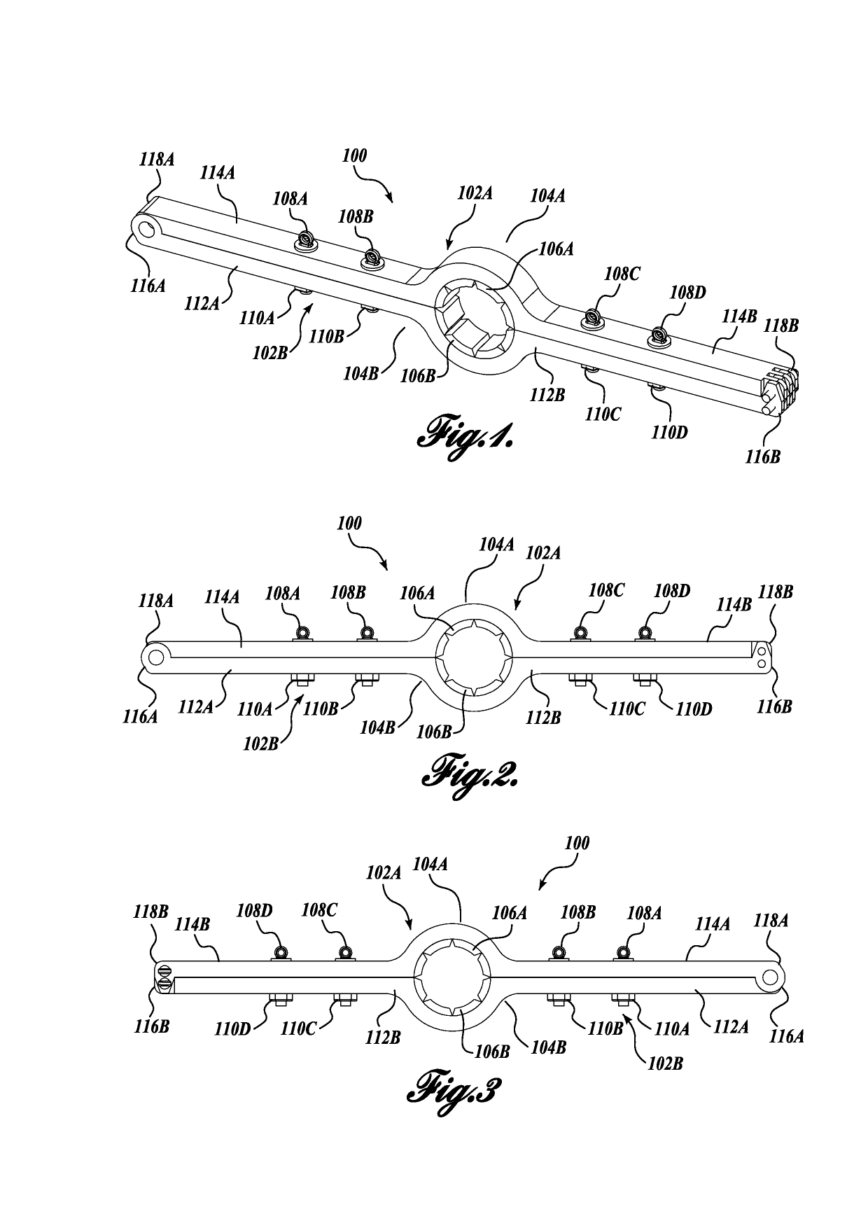

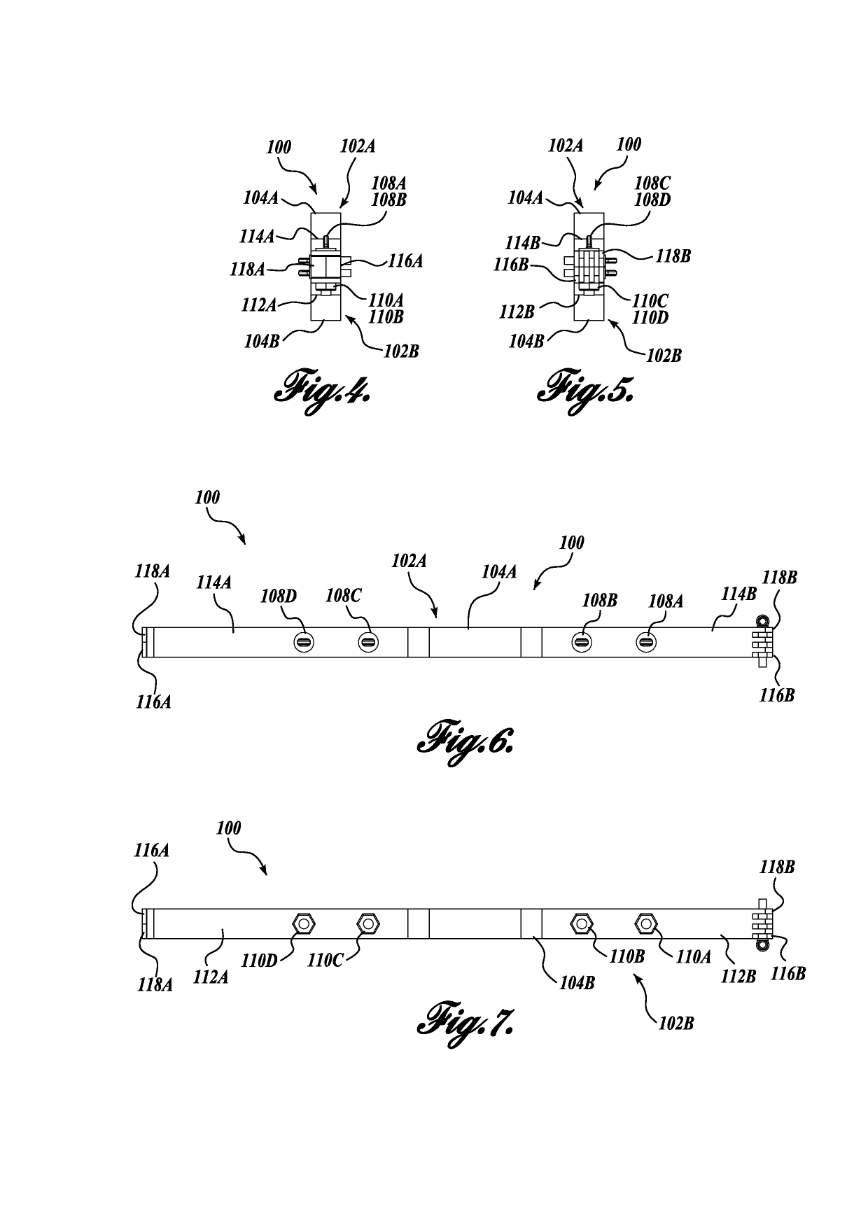

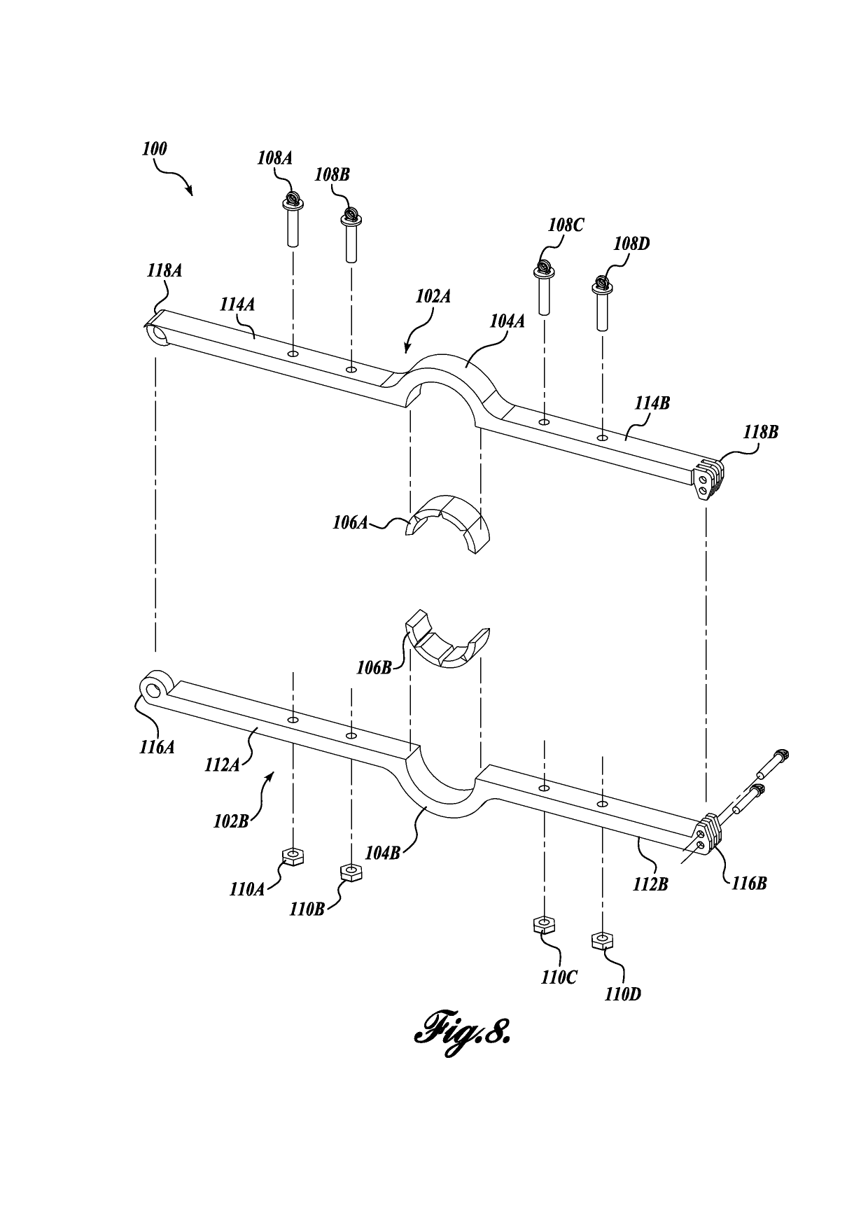

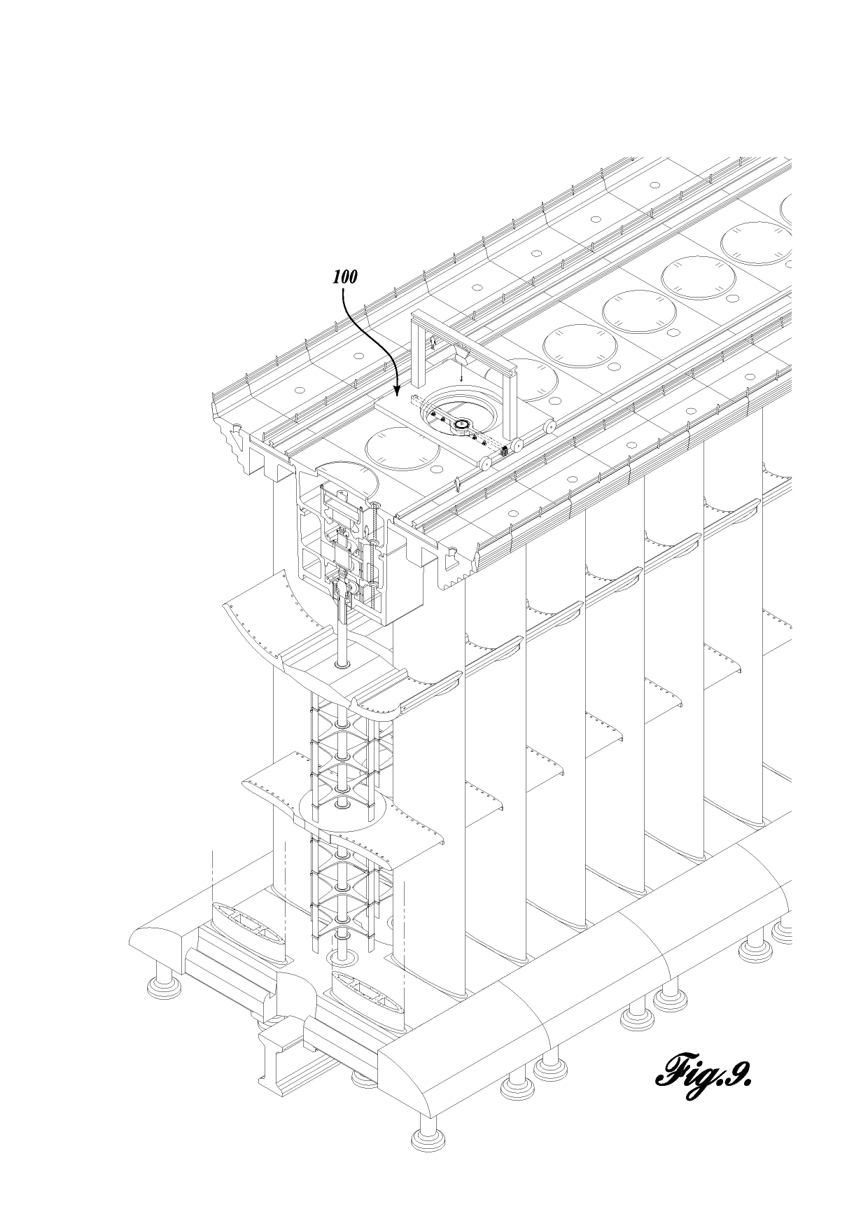

Various embodiments of the present subject matter are directed to an archetypical tool 100 that assists in the assembly, disassembly, maintenance and retrieval of elements of a hydrodynamic array, such as a drive train. See FIGS. 1-9. The tool 100 can function like a clamp in facilitating the removal of a turbine assembly from a nested machinery chamber or caisson module with the use of an overhead gantry crane. In some embodiments of the present subject matter, the tool 100 supports elements underneath a specific segment in the nested machinery chamber as it is being removed. As each segment is removed, the tool 100 is put in place to assist in the removal of a current element, and is then taken away to accommodate the removal of the next element. The tool 100 spans across a moon bay, bearing on the nested machinery chamber, which houses the machinery room, generator, and coupler assembly all the way down to the bottom bearing pocket. In various embodiments, the tool 100 has a set of first and second collars 104a, 104b with a first and second set of teeth 106a, 106b that bite (or grip) and temporarily holds the torque tube load while the section above is removed by the gantry crane.

Each set of teeth 106a, 106b fits into a curved inside surface of the first or second collar. Each tooth is a rectangular projection that is separated from another tooth in the same set with a depression that delimits the tooth. Each set may include one, two, three, or four teeth, and so on. The tool 100 is split and hinged. Once the crane picks up the load, the tool 100 is opened, swung clear of the drive train elements, and the drive train is lifted by the crane. Once the drive train is hoisted by the crane, the tool 100 is swung back into position, clamped, and locked to temporarily hold the drive train load until the section above is removed. This is repeated until the bottom pocket bearing is removed. The same process is repeated in reverse to redeploy the drive train after maintenance has been conducted.

The tool 100 comprises a first jaw 102a at the center of which is the first collar 104a and longitudinally extended away from the first collar 104a are bars 114a, 114b. Two sets of two apertures are machined into the bars 114a, 114b, each of which is spaced-apart. The bar 114a terminates in an end 118a which finishes in a cylindrical-shaped chamber with thickened walls occupying a portion of the width of the bar 114a while the remaining portion is a thinner curved wall extending from the cylindrical-shaped chamber which flushes with the edge of the bar 114a. The bar 114b terminates in an end 118b which finishes in a first comb-shaped structure. Each tooth of the comb-shaped structure is a polygon that houses a set of two adjacent apertures. Each set of adjacent apertures is coaxially aligned with other sets of adjacent apertures.

The tool 100 comprises a second jaw 102b at the center of which is the second collar 104b and longitudinally extended away from the first collar 104b are bars 112a, 112b. Two sets of two apertures are machined into the bars 112a, 112b, each of which is spaced apart. The bar 112a terminates in an end 116a which finishes in a cylindrical-shaped chamber with thickened walls occupying a portion of the width of the bar 112a while the remaining portion is a thinner curved wall extending from the cylindrical-shaped chamber which flushes with the edge of the bar 112a. The bar 112b terminates in an end 116b which finishes in a second comb-shaped structure. Each tooth of the comb-shaped structure is a polygon that houses a set of two adjacent apertures. Each set of adjacent apertures is coaxially aligned with other sets of adjacent apertures.

The first jaw 102a and the second jaw 102b are two opposable parts that can be actuated to be opened or closed for holding something between the first and second collar 104a, 104b. When the first jaw 102a is brought together with the second jaw 102b, the end 116a mates with the end 118a in that each opposing cylindrical-shaped chamber is embraced by the other's thinner curved wall to cause each opposing cylindrical-shaped chamber to be coaxially aligned. Correspondingly, when the first jaw 102a is brought together with the second jaw 102b, the teeth of the end 118b interlocks with the teeth of the end 116b. The teeth of the comb-shaped structure of the end 118b is staggered with respect to the teeth of the comb-shaped structure of the end 116b so that when they interlock, a hinge joint is created to permit motion in one plane. Bolts 120a, 120b, are rods for fastening the hinge joint created by the ends 116b, 118b, each of which has a ring-shaped head. Bolts 108a-108c are also used to fasten the first and second jaw 102a, 102b, (through the four sets of apertures), each of which also has a ring-shaped head, and each of which is further secured by corresponding nuts 110a-110c.

While illustrative embodiments have been illustrated and described, it will be appreciated that various changes can be made therein without departing from the spirit and scope of the invention.

The embodiments of the invention in which an exclusive property or privilege is claimed are defined as follows:

1. A tool for securing elements of a hydrodynamic array, comprising:
a first jaw having a first collar with bars extending from the first collar; and
a second jaw having a second collar with bars extending from the second collar, the first jaw and the second jaw being configured to be brought together as two opposable parts whose ends terminate in a hinge joint for permitting motion in one plane.

2. The tool of claim 1, wherein the first jaw and the second jaw finish in a cylindrical-shaped chamber with thickened walls occupying a portion of the width of a bar of the first jaw while the remaining portion is a thin curved wall extending from the cylindrical-shaped chamber which flushes with the edge of the bar, when the first jaw and the second jaw are brought together, each opposing cylindrical-shaped chamber is embraced by the other's thinner curved wall to cause each opposing cylindrical-shaped chamber to be coaxially aligned.

3. The tool of claim 1, wherein the first jaw and the second jaw finish in a comb-shaped structure, each tool of the comb-shaped structure being polygonal in shape, when the first jaw and the second jaw are brought together, the teeth of the comb-shaped structures interlock to create the hinge joint.

4. The tool of claim 3, wherein each tooth of the comb-shaped structure is a polygon that houses at least one aperture, each aperture being coaxially aligned with other apertures of other teeth.

5. The tool of claim 1, wherein each bar of the first and second jaw has a set of apertures for receiving ring-shaped head bolts to secure the first and second jaw together.

6. The tool of claim 1, further comprising a set of teeth that fits into the first or second collar of the first or second jaw.

7. The tool of claim 6, wherein the set of teeth fits into a curved inside surface of the first or second collar, each tooth being a rectangular projection that is separated from another tooth in the same set with a depression that delimits the tooth.
